(19) United States
(12) Patent Application Publication
(10) Pub. No.: US 2018/0282213 A1
(43) Pub. Date: Oct. 4, 2018

(54) FIBER REINFORCED COMPOSITE CORE FORMULATION

(71) Applicant: Bastian Solutions, LLC, Indianapolis, IN (US)

(72) Inventors: William A. Bastian, II, Carmel, IN (US); Garrett Clark, Carmel, IN (US)

(73) Assignee: Bastian Solutions, LLC, Indianapolis, IN (US)

(21) Appl. No.: 15/941,416

(22) Filed: Mar. 30, 2018

Related U.S. Application Data
(60) Provisional application No. 62/479,701, filed on Mar. 31, 2017.

(51) Int. Cl. C04B 20/00; C04B 16/06; C04B 14/04; C04B 16/12; C04B 7/02

(52) U.S. Cl. CPC C04B 20/0048; C04B 16/065; C04B 20/0036; C04B 20/0032; C04B 2111/40; C04B 16/12; C04B 16/0633; C04B 7/02; C04B 14/041

(57) ABSTRACT

A fiber reinforced concrete composition which cures to a cured fiber reinforced concrete composite following addition of water, the cured fiber reinforced concrete composite having a density from about 700 to 1000 kg/m³ and a compressive strength from about 5 to 15 MPa. A fiber reinforced concrete composition includes a brittle inorganic matrix precursor, a plurality of reinforcing fibers present in a range from 0.5 volume percent to less than 4 volume percent based on the total volume of the cured fiber reinforced concrete composite, and lightweight aggregate having a mean particle size in the range of 10 μm to 1000 μm, in an amount effective to achieve a target density in the cured composite not more than 1000 kg/m³. The reinforcing fibers include polypropylene fibers. The lightweight aggregate can include hollow fly ash spheres and glass microspheres. An acrylic admixture can be added to the composition.

### CROSS-REFERENCE TO RELATED APPLICATION

This application claims the benefit of U.S. Provisional Application No. 62/479,701 filed Mar. 31, 2017, which is hereby incorporated by reference.

### BACKGROUND

There are many lightweight material choices for constructing lightweight products. Some materials include wood, plastic, and lightweight concrete. For environmental and economic purposes there has been a trend to recycle and reuse products. Each of these materials has limitations. Wood tends to be economical for an initial product use however wood products tend to splinter and break after repeated use. Plastic products can be prone to damage and exhibit creep deformations under sustained loading. Both wood and plastic products are flammable. Lightweight concrete could be considered as a replacement for wood and plastic.

Lightweight concrete has many uses and is typically produced by incorporating lightweight aggregates such as expanded clay, glass or fly ash hollow spheres, entrained air bubbles using chemical admixtures, polymer beads, and/or other admixtures into a hydraulically setting matrix. Lightweight concrete affords the advantage of significant reduction in weight compared to normal weight concrete. However, the use of lightweight concrete is often limited due to its lack of ductility and low elastic modulus and compressive strength. Typically, the cracking and brittle nature of lightweight concrete is because the lightweight aggregate used in the mix is usually weaker than the cement matrix and provides little resistance to deformation, crushing and crack propagation.

Lightweight concrete exhibits even higher brittleness than concrete of normal density. The fracture toughness of the lightweight concrete can be improved through incorporation of fiber reinforcement. Adding large amounts of reinforcing fibers to a concrete mix with lightweight aggregates is problematic, since the lightweight aggregate interferes with uniform dispersion of reinforcing fibers.

A decrease in the density of lightweight concrete typically corresponds to a reduction in elastic modulus and compressive strength of the lightweight concrete composite. One technique used to decrease the density of lightweight concrete is to include air bubbles to reduce the overall weight of the lightweight concrete. However, as the density of the lightweight concrete composite decreases as more air bubbles are added to the composite, the compressive strength decreases and it becomes increasingly difficult to disperse the fibers appropriately.

Other considerations for usability of lightweight concrete include flowability and the ability to pump the lightweight concrete into forms for curing. For concrete that contains lightweight aggregate, pumping the concrete into forms can fill up the voids in the aggregate with water, making the concrete mixture dry and difficult to pump and work with. It would be desirable to provide lightweight concrete in lieu of other types of materials while maintaining elastic modulus, compressive strength and flowability.

Thus, there is a need for improvement in this field.

### SUMMARY

The applicant has previously developed a unique composite pallet made of concrete which was described in U.S. patent application Ser. No. 14/745,914 filed Jun. 22, 2015 and is hereby incorporated by reference in its entirety. The applicant has also developed a unique composite pallet made of concrete which is described in U.S. Patent application No. 62/479,975 filed Mar. 31, 2017 entitled “Composite Pallet” (Attorney Docket Number 003436-000106), which is hereby incorporated by reference in its entirety.

Applicant has discovered a number of problems that prevented the development of a commercially successful pallet design that incorporated lightweight concrete. One of the main issues was the manufacturability and durability of the composite concrete pallet. It was found that creating a unique lightweight concrete composition formulation enabled filling of frame members of the pallet with the lightweight concrete composition material. It was desired that the lightweight concrete composition could readily flow between the various frame members in the frame structure of the pallet. It was also discovered that the lightweight concrete composition could be used in other structural members that are configured and ready to receive pumpable lightweight concrete. Therefore it was desirable that the lightweight concrete also readily flow in other structural members configured to contain the concrete composition. This ensures that the pallet or other structural member is fully filled with the lightweight concrete composition and reduces the occurrence of any voids which can weaken the pallet or structural member.

It is desirable to quickly fill structural members or pallets by pumping the lightweight concrete into the members or pallets. Pumping aids added to concrete mixtures can improve pumpability. Pumping aids cannot cure all unpumpable concrete problems; they are best used to make marginally pumpable concrete more pumpable. These admixtures increase viscosity or cohesion in concrete to reduce dewatering of the paste while under pressure from the pump. Some pumping aids may increase water demand, reduce compressive strength, cause air entrainment, or retard setting time therefore each admixture is tested in a concrete formulation before use in a concrete formulation as a structural member. These side effects can be corrected by adjusting the mix proportions or adding another admixture to offset the side effects. It was discovered that an admixture added to the lightweight concrete composition helped to modify the pumpability of the lightweight concrete composition. In particular, an acrylic admixture added to the lightweight concrete composition aided in the pumpability of the concrete composition.

A decrease in the density of lightweight concrete typically corresponds to a reduction in compressive strength and elastic modulus of the lightweight concrete composite. As mentioned previously, an admixture added as a pumping aid can also decrease the compressive strength of the lightweight concrete composite. During the development of the lightweight concrete composition, reinforcing fibers were added to the concrete composition to increase the toughness of the cured concrete and form a fiber reinforced concrete composite. One difficulty that was encountered by adding reinforcing fibers to the lightweight concrete composition was adequate dispersion of the reinforcing fibers in the concrete composition. Adequate dispersion of the reinforcing fibers became more problematic as the composite density was decreased. It was discovered that hollow microspheres or other appropriate lightweight aggregate added to the fiber reinforced concrete composite had a ball bearing effect on the fiber reinforced concrete composite and helped to adequately disperse the reinforcing fibers in the fiber reinforced concrete composite.

It was discovered that the compressive strength of the unique formulation of cured fiber reinforced concrete composite was surprisingly high being in the range of 5 to 15 MPa with a very low density being in the range of about 700 to 1000 kg/m³. It was also discovered that the stiffness was surprisingly high in the range of about 5 to 10 GPa. Moreover, it was discovered that the cured fiber reinforced concrete composite had no strain hardening behavior in tension.

The fiber reinforced concrete composite once cured provides the requisite strength to a structural member, such as a pallet since the sheet metal that is used to form the frame structure is too thin by itself to provide the strength for the pallet. Once cured inside the frame structure, the fiber reinforced concrete composite provides the required strength and stiffness so that the pallet has price parameters, structural strength capabilities, and weight as well as other properties comparable to that of wooden pallets, if so desired. The sheet metal for the frame structure or other structural member in essence acts as an exoskeleton or mold in which the fiber reinforced concrete composite is cured and housed. Fiber reinforcement ribs can also be embedded in the fiber reinforced concrete composite so as to provide additional lightweight strength.

The fiber reinforced concrete composite is durable so that the pallet or other structural member can be reused, and is inexpensive so as to have a cost comparable to other material choices. The fiber reinforced concrete composite has been configured and/or formulated to have a weight, strength and stiffness comparable to other material choices such as wood. By being made of concrete, the pallet or structural member is able to be heat treated, fumigated, and/or otherwise exposed to various chemicals with little risk for damage. Unlike wood, concrete is typically inflammable which is especially helpful in reducing the risk of fire in large manufacturing and/or warehousing operations.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a flow diagram of a technique for manufacturing a fiber reinforced concrete composite according to one embodiment.

FIG. 2 is a top perspective view of a pallet according to one embodiment.

FIG. 3 is a top perspective view of another pallet that can be filled with the fiber reinforced concrete composite.

### DESCRIPTION OF THE SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

One embodiment of a fiber reinforced concrete composition includes a cured fiber reinforced concrete composite having a density in the range from 700 to 1000 kg/m³ and a compressive strength in the range from about 5 to 15 MPa. The cured fiber reinforced concrete composite has a tensile strain capacity between 0 and 2%. The cured fiber reinforced concrete composite has an elastic modulus in the range from about 5 to 10 GPa. As will be recognized, the resulting material is lightweight and has relatively high stiffness and strength in compression. Moreover, the resulting material from this concrete composition has low creep.

The fiber reinforced concrete composition includes a brittle inorganic matrix precursor, a matrix of interactive reinforcing fibers of less than 4 volume percent, and at least one lightweight aggregate or filler having a mean particle size in the range of 10 μm to 1000 μm, in an amount effective to achieve a target density in the cured composite not more than 1000 kg/m³. These ingredients may be supplied separately, or in the form of one or more dry mix components. Water is added to these components to form a hydraulically settable mixture of the desired consistency. Additional ingredients such as rheological modifiers, thixotropes, plasticizers, superplasticizers or high range water reducer, viscosity agent or modifier, acrylic, water reducing agents, setting retardants, setting accelerants, shrinkage reduction agent, expansion agent, acrylic and other similar materials may be added as desired.

The brittle inorganic matrix precursor is meant to include one or more conventional hydraulic cements or inorganic polymers as a hydraulic inorganic component. “Hydraulic cement” is meant to include a cement which sets, or hardens, in the presence of water, including but not limited to Portland cement, blended Portland cement, expansive cement, rapid setting and hardening cement, calcium aluminate cement, magnesium phosphate, and mixtures thereof. For economical reasons, hydraulic cements are preferred for use in the subject invention. However, epoxy or inorganic polymers such as geopolymers based on silicoaluminates may also be used.

The reinforcing fibers used are present in an amount of 0.5 to less than 4 volume percent based on the total volume of the cured fiber reinforced concrete composite. In one composition, the reinforcing fibers used are between 0.5 to 1.0 volume percent based on the total volume of the cured fiber reinforced concrete composite. In another composition, the reinforcing fibers used are less than 0.5 volume percent based on the total volume of the cured fiber reinforced concrete composite. The nature of the fibers must meet certain criteria. For example, the reinforcing fibers must be of a certain strength and modulus. The reinforcing fibers may exhibit low bond strength to the matrix. Fibers which do not meet such limitations may be added in addition to those which do meet the limitations, but are preferably absent. Fiber length is about 4 mm or greater in one example, and generally limited by processing constraints to 30 mm or less. The average diameter of the fibers is from 10 to 100 μm. In one form, the average diameter of the fibers is from 10 to 60 μm. In another form, the average diameter of the reinforcing fibers is from 10 μm to 30 μm. The reinforcing fibers have a tensile strength in the range of 500 MPa to 700 MPa and a modulus of elasticity in the range of 5 GPa to 10 GPa. In one form, the modulus of elasticity of the reinforcing fibers is about 7 GPa. Fibers with a higher elastic modulus are typically used.

Reinforcing fibers that hydrolyze under basic conditions, such as polypropylene fibers, are preferred as they are inexpensive and do not tend to rupture when cracks form which is in part due to their low stiffness. The reinforcing fibers used can be made of other materials including cellulose, low density polyethylene fibers, any synthetic fiber, natural fiber, metallic fiber, carbon, nylon, glass, AR glass, basalt, wollasstonite, or acrylic fiber. Some benefits of including reinforcing fibers in a lightweight concrete composition are the fibers can improve mix cohesion, improve pumpability of the lightweight concrete over long distances, improve freeze-thaw resistance, improve impact resistance and abrasion resistance, and increase resistance to plastic shrinkage during curing, to name a few benefits.

Reinforcing fibers often have specified interfacial chemical bonding below 4.0 J/m² however in the present formulation the reinforcing fibers may have an interfacial chemical bonding above 4.0 J/m². The reinforcing fibers do not need to chemically bond with the cement as in other high performance cementitious mixes. Fibers with a high chemical bond strength tend to rupture upon crack formation. Generally speaking, polypropylene fibers do not have a high chemical bond and remain intact upon crack formation. The remaining properties of the reinforcing fibers may be obtained from the fiber manufacturer or determined by standard test methods.

The lightweight aggregate or filler has a particle size in the range of 10 μm to 1000 μm, in an amount effective to achieve a target density in the cured composite not more than 1000 kg/m³. Alternatively, the lightweight aggregate or filler can have a mean particle size in the range of 10 μm to 100 μm in an amount effective to achieve a target density in the cured composite not more than 1000 kg/m³. In another form, the lightweight aggregate or filler is present in an amount effective to achieve a target density in the cured composite between 700 to 1000 kg/m³. In yet another form, the lightweight aggregate or filler is present in an amount effective to achieve a target composite density between 800 to 1900 kg/m³ with 1.0 to 3.0 volume percent of reinforcing fibers based upon the volume of the cured fiber reinforced concrete composite with the addition of water.

The lightweight aggregate or filler can include hollow fly ash spheres, expanded glass, calcium silicate hydrate, expanded clay, natural lightweight aggregate, expanded shale, vermiculite, expanded clay, expanded slate, air entrainer, synthetic or foam beads, hollow aluminum silicate sphere, microballoons, or microspheres which are either hollow or of low density or any combination of these materials. Microspheres are hollow balls having a thin outer wall that surrounds air or gas. The microspheres are typically made of glass or ceramic. One example of hollow microsphere is available from 3M Company under the tradename 3M™ Glass Bubbles K1 with a density of 0.125 g/cc, a particle size distribution between 60 to 69 μm, a mean particle size of 65 μm, and made of soda-lime-borosilicate glass with a crush strength of 250 PSI. In one form the microspheres have a mean diameter in the range of 10 μm to 100 μm. The microspheres used are obtained from a coal burning process. 3M sells these types of microspheres in the United States as K37 glass bubbles. While not certain, it is thought that the microspheres enhance workability. In essence, the microspheres lubricate the material due to their round or ball bearing shape.

The lightweight aggregate or filler in one example can include expanded glass formed as microspheres sold as K37 glass bubbles by 3M. In one form, the expanded glass has a particle size distribution between 10 and 1000 μm, a bulk density of between 230 to 530 kg/m³, a particle density of between 950 to 400 kg/m³, and a crushing resistance between 1.6 to 2.8 N/mm² due to its spherical structure.

In another example, the lightweight aggregate or filler can include microballoons having walls made of polymer, glass, ceramic, polymer, or fly ash. One example of microballoon includes a hollow micro-bubble having a density of 16.7 kg/m³, a size distribution of 40-120 μm, an average mean size of 80 μm, and composed of a polymer. In one formulation, the microballoons can have a diameter of from between 10 to 100 μm.

The lightweight aggregate or filler can also include hollow fly ash spheres. One type of hollow fly ash sphere includes a hollow aluminosilicate sphere made by Cenostar Corporation under the tradename Cenosphere Microsphere with a density of 60 to 0.85 g/cc, a particle size distribution between 200 to 600 μm, a bulk density of 0.35 g/cc, a true density less than 0.98 g/cc, and a crush strength between 1600 and 3200 PSI.

The lightweight aggregate or filler can include gas bubbles or gas filled voids. The gas bubbles or voids can be introduced during processing of the hydraulically settable mixture by physical means, i.e., frothing or aeration, or may be chemically induced. If gas bubbles are used as the sole lightweight aggregate, it is preferred that stabilizing substances be added to assist in preventing coalescence of adjoining bubbles, or that the volume percent be limited so as to provide a cured density of between 700 kg/m³ to 1000 kg/m³. Gas bubbles are very useful when used with other lightweight aggregates. In such formulations, the volume fraction of gas bubbles can be kept small so that coalescence will be minimal.

Water is added to the brittle inorganic matrix precursor, fibers, and lightweight aggregate to achieve a desired consistency. The amount of water to add is about 0.5 to about 0.8 parts water to each one part cement which does not include reinforcing fibers or lightweight aggregate. The order of mixing is not critical and all components can be added at the same time, one component at a time, or in any order.

A viscosity control agent or modifier can be added to the fiber reinforced concrete composition to prevent segregation, since the viscosity control agent is much lighter than cement and any dense aggregate. Numerous viscosity control agents or modifiers can be used such as methylcellulose, hydroxypropylmethylcellulose, cellulose ethers, copolymers, starch ethers, polyacrylamides, or polymeric thickeners such as polyvinyl alcohol polymers. The amount of viscosity control agent may be any amount which is effective, generally between about 0.5 to 5%, based on the weight of the cement component.

A high range water reducing admixture or a water reducing agent such as a superplasticizer can be added to the fiber reinforced concrete composition. Superplasticizers, are essentially high-range water reducers in concrete having a slump greater than 190 mm (7 ½ in.), yet maintaining cohesive properties. These admixtures are added to concrete with a low-to-normal slump and water-cement ratio to make high-slump flowing concrete. Flowing concrete is a highly fluid but workable concrete that can be placed with little or no vibration or compaction while still remaining essentially free of excessive bleeding or segregation. The water reducing agent or superplasticizer modifies the working consistency of the fiber reinforced concrete composition after adding water to the composite. The amount of water reducing agent can vary with the particular components of the mix as well as the amount of water used, but is generally in the range of 0.15-0.3% based on the amount of cement. Some examples of superplasticizers include synthetic polymers, sulfonated melamine formaldehyde condensates, sulfonated naphthalene formaldehyde condensates, lignosulfonates, and polycarboxylates.

Other admixtures can be added to the fiber reinforced concrete composition to improve pumpability. For example, an acrylic admixture can added to the fiber reinforced concrete composition to aid the workability and/or pumpability of the concrete composition. Other admixtures that can be added to the fiber reinforced concrete composition to improve pumpability include organic and synthetic polymers, organic flocculents, organic emulsions of paraffin, coal tar, asphalt, bentonite and pyrogenic silica.

Another admixture that can be added to the fiber reinforced concrete composition includes accelerators. Accelerators accelerate or increase setting and early-strength of the fiber reinforced concrete composition. Some accelerators include calcium chloride, triethanolamine, sodium thiocyanate, calcium formate, calcium nitrite, and calcium nitrate, to name a few.

Another admixture that can be added to the fiber reinforced concrete composition includes retarders. Retarders retard or slow setting time of the fiber reinforced concrete composition. Some retarders include lignin, borax, sugars, tartaric acid and salt, to name a few.

Another admixture that can be added to the fiber reinforced concrete composition includes shrinkage reduction agents. Shrinkage reduction agents reduce the drying shrinkage of the cured concrete. Some reduction agents include polyoxyalkylene alkyl ether and propylene glycol, to name a few.

Another admixture that can be added to the fiber reinforced concrete composition includes an expansion agent which can help to effectively compensate shrinkage deformations of the cured fiber reinforced concrete composite. One expansion agent includes calcium sulphoaluminate.

One exemplary mix was prepared to illustrate the invention. The exemplary mix included approximately: 315 g of water, 400 g of cement, 40 g of glass microspheres, 380 g of hollow fly ash sphere or a hollow aluminosilicate sphere, 4.5 g of superplasticizer, 1.8 g of viscosity agent, and 9 g of polypropylene reinforcing fibers. The cement used was Type 1 Portland Cement. The hollow microsphere used was from 3M Company under the tradename 3M™ Glass Bubbles K1 with a density of 0.125 g/cc, a particle size distribution between 60 to 69 μm, a mean particle size of 65 μm, and made of soda-lime-borosilicate glass with a crush strength of 250 PSI. The hollow fly ash sphere used included a hollow aluminosilicate sphere made by Cenostar Corporation under the tradename Cenosphere Microsphere with a density of 60 to 0.85 g/cc, a particle size distribution between 200 to 600 μm, a bulk density of 0.35 g/cc, a true density less than 0.98 g/cc, and a crush strength between 1600 and 3200 PSI. It was discovered that a close almost 1:1 ratio of cement to hollow fly ash sphere converted to a target density of the cured fiber reinforced concrete composite between 750 kg/m³ to 950 kg/m³. The superplasticizer was Melflux® superplasticizer from BASF Corporation. The viscosity control agent was Starvis® stabilizer/rheology modifier agent from BASF Corporation. In one example, a flow spread test is used to measure flowability. The density of the lightweight concrete composite was 900 kg/m³ and the cured fiber reinforced concrete composite had a compressive strength of 17.81 MPa when tested. In one example, a hydraulic test machine was used to perform the compression test.

Table 1 below provides one example of the fiber reinforced concrete formulation.

TABLE 1

| | | SPECIFIC | Formula | | Recommended |
|---|---|---|---|---|---|
| MATERIAL | Function | GRAVITY | WEIGHT | VOLUME | Dosage |
| Water (g) | | 1 | 340 | 0.340 | |
| Cement, Type III | | 3.15 | 350 | 0.111 | |
| (g) | | | | | |
| 3M K37 Glass | Lightweight | 0.37 | 40 | 0.108 | |
| Bubbles (g) | Aggregate | | | | |
| Cenosphere, 250 | Lightweight | 0.5 | 430 | 0.860 | |
| micron (g) | Aggregate | | | | |
| | | | 0 | | |
| Bonding Agent, | Bonding agent | | 10 | | |
| SikaLatex R (g) | and | | | | |
| | pumpability | | | | |
| | increaser | | | | |
| SP, Melfux (g) | Super | | 4.5 | | |
| | Plasticizer/ | | | | |
| | Water Reducer | | | | |
| MC, Starvis (g) | Viscosity | | 2.7 | | |
| | Modifier | | | | |
| PP Fiber 9 mm | Reinforcement | | 9 | | |
| (g) | and crack | | | | |
| | control | | | | |
| Possible Replacements/Additions | | | | | |
| MG 7920 (ml) | Super | | 0 | | 2.5 |
| | Plasticizer/ | | | | |
| | Water Reducer | | | | |
| Master Matrix 33 | Viscosity | | 0 | | |
| (ml) | Modifier | | | | |
| M X-Seed 55 (ml) | Accelerator, | | 0 | | |
| | strength | | | | |
| | increaser | | | | |
| Master Sure Z60 | Workability | | 0 | | |
| (ml) | Extender | | | | |
| VMA 450 (ml) | Viscosity | | | | |
| | Modifier | | | | |
| Total Volume | | | | 1.419 | |
| (litres) | | | | | |
| Total Batch | | | | | |
| Weight (grams) | | | 1186 | | |
| Theoretical | | | | | |
| Density (kg/l) | | | 0.836 | | |

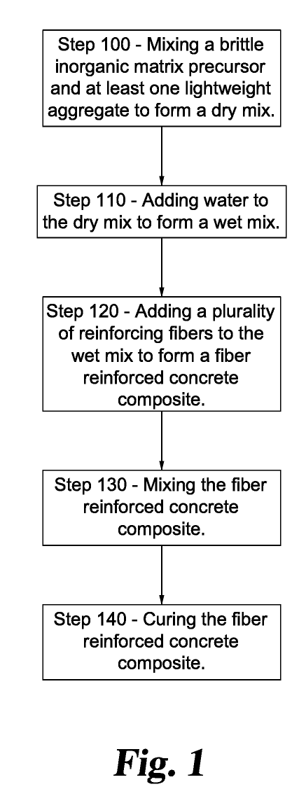

Illustrated in FIG. 1 is one technique for manufacturing a cured fiber reinforce concrete composite. The mixture is prepared in a mixer with a planetary rotating blade or some other form of mixing the ingredients together. In Step 100, a brittle inorganic matrix precursor and at least one lightweight aggregate having a mean particle size in the range of 10 μm to 1000 μm, in an amount effective to achieve a target density in the cured composite not more than 1000 kg/m3 are mixed together for a time period to form a dry mix. In one form, the time period for mixing was 1-2 minutes to form the dry mix, although the time period can be longer or shorter as desired. In Step 110, water was added to the dry mix to form a wet mix. Optionally, superplasticizer or viscosity agent can be added with the water and mixed for a time period. In Step 120, a plurality of reinforcing fibers is added to the wet mix to form a fiber reinforced concrete composition, the reinforcing fibers having a minimum average length of about 4 mm, present in a range from 0.5 volume percent to less than 4 volume percent based on the total volume of the fiber reinforced concrete composite. In Step 130, the fiber reinforced concrete composition is mixed for about 5 to 7 minutes as desired. The time period for mixing can be longer or shorter as desired. The reinforcing fibers are mixed until all or most of the fibers are dispersed into the fiber reinforced concrete composition. In Step 140, the fiber reinforced concrete composition is cured at a temperature of about 50 degrees Celsius. Optionally, the curing the fiber reinforced concrete composition occurs in a humid environment.

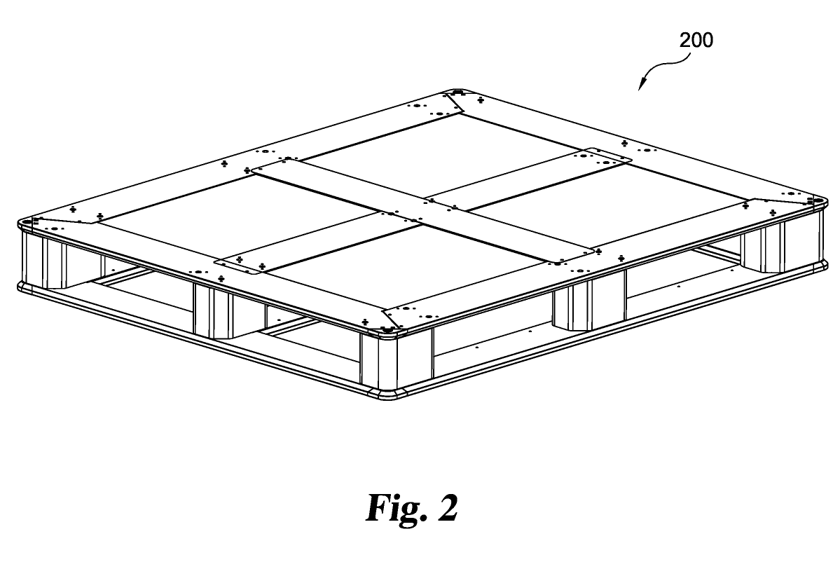

The fiber reinforced concrete composite can be cured through normal curing processes. Alternatively or additionally, the fiber reinforced concrete composite is cured through a steam curing process and/or via an autoclave that applies pressure or a vacuum to the formed pallet. Further, the curing can be accelerated by exposing the concrete to CO₂. Optionally, if the fiber reinforced concrete composite is placed in a structure such as a pallet 200 illustrated in FIG. 2, the concrete composite will continue to cure even after manufacturing. For instance, the concrete in the pallet 200 can cure while the pallet 200 is stored in a warehouse and/or during shipping to a customer. In one example, the fiber reinforced concrete composite is cured at 125 degrees Fahrenheit using a wet curing or steam curing process. In this example, the fiber reinforced concrete composite is cured for 7 days but can be cured longer or shorter as desired. In another example, the fiber reinforced concrete composite is cured at room temperature of between about 65 to 80 degrees Fahrenheit for 28 days but can be cured longer or shorter as desired.

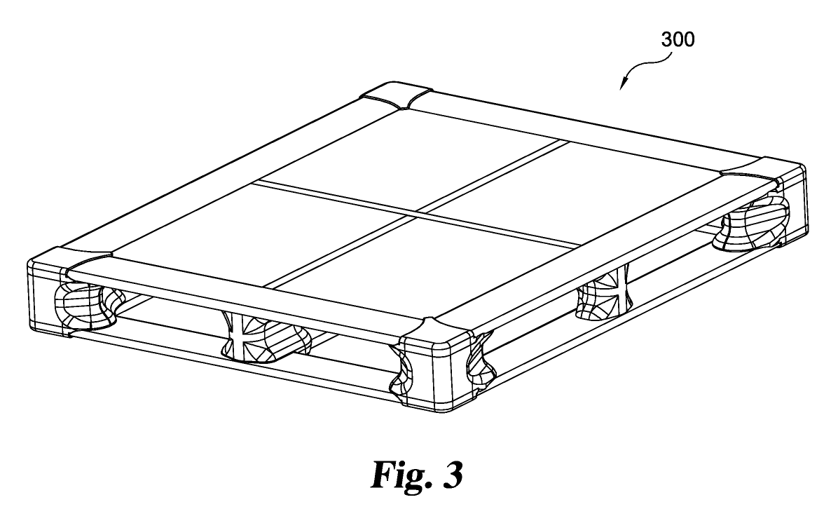

A more complete description of the pallet 200 that is filled with the fiber reinforced concrete composite or other fill material is provided in U.S. Patent Application No. 62/479,975 filed Mar. 31, 2017 entitled “Composite Pallet” (Attorney Docket Number 003436-000106), which is hereby incorporated by reference in its entirety. FIG. 3 shows another example of a pallet 300 that can be filled with this composite concrete formulation.

### GLOSSARY OF TERMS

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“Bottom Deck” generally refers to one or more panels and/or assemblies of boards that form the load-bearing surface of the pallet that typically rests against another object such as the floor, ground, other pallet, and/or other unit load. The bottom deck usually, but not always, includes jack openings that allow pallet jack wheels to engage the floor or ground.

“Brittle Inorganic Matrix Precursor” refers generally to one or more conventional hydraulic cements or inorganic polymers as a hydraulic inorganic component and/or epoxy or inorganic polymers such as geopolymers based on silicoaluminates. “Hydraulic cement” is meant to include a cement which sets, or hardens, in the presence of water, including but not limited to Portland cement, blended Portland cement, expansive cement, rapid setting and hardening cement, calcium aluminate cement, magnesium phosphate, and mixtures thereof. May also be used.

“Carbon Fiber Material” refers generally to a type of fiber reinforced material that includes, but is not limited to, a material of thin, strong crystalline filaments of carbon, used as a strengthening material, such as in resins and ceramics. For example, carbon fiber materials include strong lightweight synthetic fibers made especially by carbonizing a fiber at high temperatures.

“Cement” generally refers to a binder that sets, hardens, and adheres to other materials, binding them together. Typically, but not always, cement is inorganic, often lime or calcium silicate based. By way of non-limiting examples, cement can include a powdery substance made with calcined lime and clay. In one form, cement can be mixed with water to form mortar. In another form, when mixed with water, cement can bind sand and gravel (or other aggregate) together to produce concrete. Cement can be categorized as being hydraulic or non-hydraulic which depends on the ability of the cement to set in the presence of water. Non-hydraulic cement typically does not set in wet conditions or under water. Non-hydraulic cement sets as the cement dries and reacts with carbon dioxide in the air. Once set, the non-hydraulic cement is normally resistant to chemical attack. Hydraulic cement, such as Portland cement, sets and becomes adhesive due to a chemical reactions between the dry ingredients and water. The chemical reaction results in mineral hydrates that are not very water-soluble and so are quite durable in water and safe from chemical attack. Hydraulic cement is typically able to set in wet conditions or under water. Once set, the hydraulic cement can protect the hardened material from chemical attack.

“Concrete” generally refers to a material made from a mixture of broken stone or gravel, sand, cement, and water that can be spread/poured into molds and/or extruded to form a stone like mass on hardening.

“Deck” generally refers to a surface of a pallet, including one or more boards and/or panels, with or without space between the elements. Pallets can typically include one or more of the following types of decks: a top deck and/or a bottom deck. The directional terms “top” and “bottom” when referring to these types of deck are common nomenclature used in industry, and it is not the intent that these directional terms limit the types of decks to a specific orientation or direction. For example, in a reversible pallet, the pallet has identical or similar top and bottom decks that can be flipped on either face of the pallet to support the unit load.

“Elastic” generally refers to a solid material and/or object that is capable of recovering size and/or shape after deformation. Elastic material typically is capable of being easily stretched, expanded, and/or otherwise deformed, and once the deforming force is removed, the elastic material returns to its original shape. By way of non-limiting examples, elastic materials include elastomers and shape memory metals. For instance, elastic materials can include rubber bands and bungee cords.

“Engineered Cementitious Composite” (ECC), also known as “bendable concrete” or “engineered cementitious concrete”, generally refers to a type of concrete composite material that is reinforced with short random polymer fibers, such as polyvinylalcohol (PVA) fibers. These polymer fibers may be used in a low volume fraction, such as 2-3% by volume, in a concrete mixture to create a concrete matrix with greater tensile strain capacities than a traditional concrete mixture. In other words, ECC is one specific species of fiber reinforced concrete (FRC) that uses polymer fibers so as to provide superior qualities. Unlike regular concrete, ECC has a strain capacity in the range of 3-7%, compared to 0.1% for Ordinary Portland Cement (OPC). ECC therefore acts more like a ductile metal than a brittle concrete (as does OPC). Tests done on ECC material have shown a higher relative strength in tension, greater resistance to catastrophic fatigue cracking, increased durability under reversed loading, and greater dynamic tensile loading capability under projectile impact. More specifically, in some cases, the tensile strain capacity may be approximately 500 times greater than that of standard concrete aggregate mixtures. In one example, the polymer fibers in the concrete mixture are selected to optimize the concrete matrix for the highest tensile strain capacity. PVA fibers are often selected due to the high chemical bonds between the PVA fiber and the concrete and/or the appropriate frictional stresses at this interface. If the interaction between the fibers and the concrete mixture is too strong, the fibers will not stretch properly and the supporting concrete matrix may rupture. In one embodiment, the strength of the interaction between the fibers and the concrete mixture is in a selected range such that when microcracks form, they will propagate to other locations in the concrete matrix, thus causing strain hardening in the macro level of the ECC material. There are a number of different varieties of ECC.

“Lightweight ECC” or “low density ECC” generally refers to ECC that contains air voids, glass bubbles, polymer spheres, and/or lightweight aggregate. Compared to other lightweight concretes, lightweight ECC has superior ductility.

“Self-compacting ECC” generally refers to an ECC material that can flow under its own weight. For instance, a self-compacting ECC material is able to fill a mold containing elaborate pre-positioned steel reinforcement without the need of vibration or shaking to ensure even distribution. Self-compacting ECC contains chemical admixtures to decrease viscosity and control particle interactions with mix proportioning.

“Sprayable ECC” generally refers to an ECC material that is able to be pneumatically sprayed. Sprayable ECC includes one or more superplasticizing agents and viscosity-reducing admixtures.

“Extrudable ECC” generally refers to an ECC material that is formulated for extrusion. Extrudable ECC materials have both higher load capacity and higher deformability than other extruded fiber-reinforced composite materials.

“Fastener” generally refers to a hardware device that mechanically joins or otherwise affixes two or more objects together. By way of nonlimiting examples, the fastener can include bolts, dowels, nails, nuts, pegs, pins, rivets, screws, and snap fasteners, to just name a few.

“Fiber Reinforced Concrete” (FRC) generally refers to concrete containing fibrous material which increases its structural integrity. FRC contains short discrete fibers that are uniformly distributed and randomly oriented. These fibers can include steel fibers, glass fibers, synthetic fibers, and/or natural fibers that tend to vary the properties to the concrete. The characteristics of FRC can change by changing concretes, fiber materials, geometries, distribution, orientation, and/or densities.

“Fiber Reinforced Material” refers generally to any material including fibers of high strength and modulus embedded in or bonded to a matrix with distinct interfaces (boundary) between them. In one example, the fiber reinforced material includes a fiber reinforcement and an encapsulating matrix. A fiber (a fiber or fiber tow typically includes a bundle of filaments) is generally considered to be continuous if the fiber extends from one edge of a ply of material to another edge, most often the opposing edge. While all fibers in a fiber reinforced material need not be continuous, a substantial majority of the fibers will be continuous in some examples.

“Frame” generally refers to a structure that forms part of an object and gives strength and/or shape to the object.

“Lightweight ECC” or “low density ECC” generally refers to ECC that contains air voids, glass bubbles, polymer spheres, and/or lightweight aggregate. Compared to other lightweight concretes, lightweight ECC has superior ductility.

“Mean Diameter” or average diameter generally refers to the sum of the diameters divided by the number of diameters summed.

“Mean Length” or average length generally refers to the sum of the lengths divided by the number of lengths summed.

“Mean Particle Size” generally refers to a particle size measured in microns by volume.

“Microspheres” or “Microparticles” generally refer to small typically spherical particles, with diameters in the micrometer range (usually 1 μm to 1000 μm). Microspheres are generally made from various natural and synthetic materials. The microspheres can be made from recycled material. Glass microspheres, polymer microspheres, and ceramic microspheres are common types of microspheres. More specifically, microspheres can include glass, polyethylene, polystyrene, and/or expandable microspheres. The microspheres can be solid or hollow and can vary widely in density.

“Mortise and tenon joint” generally refers to a structure where at least two parts are interlocked together through a mortise hole or opening and the tenon tongue or member. Typically, but not always, the components attached together with the mortise and tenon joint are oriented transverse to one another, usually at a 90 degree angle. The mortise is a hole, slot or other opening in which the tenon is received. By way of nonlimiting examples, the mortise can include an open mortise, a stub mortise, a through mortise, a wedged half-dovetail mortise, and through-wedge half dovetail designs, to name just a few. The tenon is a projecting structure that is received in the mortise. By way of nonlimiting examples, the tenon can include stub tenon, through tenon, loose tenon, biscuit tenon, pegged/pinned tenon, tusk tenon, teasel tenon, top tenon, hammer-headed tenon, and half shoulder tenon type designs, to name just a few examples. Typically, but no always, the mortise and tenon have similar dimensions to promote a tight fit between the two attached components.

“Pallet” generally refers to a portable platform or other structure on which goods or items can be assembled, stacked, stored, packaged, handled, transported, and/or moved, such as with the aid of a forklift or pallet jack, as a unit load. Typically, but not always, the pallet is rigid and forms a horizontal base upon which the items rest. Goods, shipping containers, and other items are often placed on a pallet secured with strapping, stretch wrap, and/or shrink wrap. Often, but not always, the pallet is equipped with a superstructure. In one form, the pallet includes structures that support goods in a stable fashion while being lifted by a forklift, pallet jack, front loader, and/or other lifting devices. In particular, pallets typically include a top deck upon which items are stacked, a bottom deck that rests on the ground, and a spacer structure positioned between the top and bottom decks to receive the forks of the forklift or pallet jack. However, the pallets can be configured differently. For example, the term pallet is used in a broader sense to include skids that have no bottom deck. One or more components of the pallet, or even the entire pallet, can be integrally formed together to form a single unit. By way of non-limiting examples, these pallets can include stringer, block, perimeter, skid, solid deck, multiple deck board, panel-deck, slave, double-deck (or face), single-way entry, two-way entry, four-way entry, flush, single-wing, double-wing, expendable, limited-use, multiple-use, returnable, recycled, heat treated, reversible, non-reversible, and/or warehouse type pallets.

“Polystyrene Foam” generally refers to a substance in which pockets of gas are trapped in a synthetic aromatic polymer made from the monomer styrene. In other words, polystyrene foam generally refers to a multicellular expanded and/or extruded synthetic resinous material. The polystyrene material is typically, but not always, foamed with the aid of a blowing agent, such as chlorofluorocarbon (now typically banned due to environmental concerns), pentane, and/or carbon dioxide gas blowing agents, to name just a few examples, in order to form bubbles in the polystyrene foam. The trademark STYROFOAM® by Dow Chemical Company is commonly used to refer to all forms of polystyrene foam products. The term polystyrene foam is used in a broad context to include expanded polystyrene (EPS) and extruded polystyrene.

“Seam” generally references to an interface where two or more metal sheets are rolled or otherwise folded to join the two sheets together. Typically, but not always, the seam is formed near or at the edges of the sheet. By way of non-limiting examples, the seams can include a grooved seam joint, a single bottom seam, a lap seam, a countersunk lap seam, an outside lap seam, a standing seam, a flat lock seam, a grooved flat lock seam, a lap bottom seam, and/or an insert bottom seam, to name just a few.

“Self-compacting ECC” generally refers to an ECC material that can flow under its own weight. For instance, a self-compacting ECC material is able to fill a mold containing elaborate pre-positioned steel reinforcement without the need of vibration or shaking to ensure even distribution. Self-compacting ECC contains chemical admixtures to decrease viscosity and control particle interactions with mix proportioning.

“Snap-Fit Connector” or “Snap-Fit Connection” generally refers to a type of attachment device including at least two parts, with at least one of which being flexible, that are interlocked with one another by pushing the parts together. The term “Snap-Fit Connector” may refer to just one of the parts, such as either the protruding or mating part, or both of the parts when joined together. Typically, but not always, the snap-fit connector includes a protrusion of one part, such as a hook, stud and/or bead, that is deflected briefly during the joining operation and catches in a depression and/or undercut in the mating part. After the parts are joined, the flexible snap-fit parts return to a stress-free condition. The resulting joint may be separable or inseparable depending on the shape of the undercut. The force required to separate the components can vary depending on the design. By way of non-limiting examples, the flexible parts are made of a flexible material such as plastic, metal, and/or carbon fiber composite materials. The snap-fit connectors can include cantilever, torsional and/or annular type snap-fit connectors. In the annular snap-fit type connector, the connector utilizes a hoop-strain type part to hold the other part in place. In one form, the hoop-strain part is made of an elastic material and has an expandable circumference. In one example, the elastic hoop-strain part is pushed onto a more rigid part so as to secure the two together. Cantilever snap-fit type connectors can form permanent type connections or can be temporary such that the parts can be connected and disconnected multiple times. A multiple use type snap-fit connector typically, but not always, has a lever or pin that is pushed in order to release the snap-fit connection. For a torsional snap fit connector, protruding edges of one part are pushed away from the target insertion area, and the other part then slides in between the protruding edges until a desired distance is reached. Once the desired distance is reached, the edges are then released such that the part is held in place.

“Spacer Structure” generally refers to any component, part, object, device, and/or assembly that separates the top deck from an object on which the pallet rests, such as the ground, floor, other pallet, and/or other unit load. By way of nonlimiting examples, the spacer structure can include one or more blocks, stringers, and/or other spacers. Typically, but not always, the spacer structure defines one or more fork entries that each form an entry for admitting one or more forks of a forklift or pallet jack. The fork entry can for instance be formed by the space created between the top and bottom decks by stringers and/or blocks as well as one or more notches in the stringers or other parts of the pallet to name just a few examples. In one form, the fork entries can be located on opposite ends of the pallet to create a two-way entry pallet, and in another form, the fork entries can be located on both opposite ends and opposite sides of the pallet to create a four-way entry pallet. In other examples, the spacer structure can include more or less, and even none, fork entries.

“Sprayable ECC” generally refers to an ECC material that is able to be pneumatically sprayed. Sprayable ECC includes one or more superplasticizing agents and viscosity-reducing admixtures.

“Top Deck” generally refers to one or more panels and/or assemblies of boards that form the load carrying face of the pallet on which goods or items are supported.

“Minimum Average Length” generally refers to a minimum required length of the summation of the lengths of the individual reinforcing fibers included in the plurality of reinforcing fibers divided by the total number of individual reinforcing fibers.

“Volume Percent” generally refers to the weight of the reinforcing fibers divided by the volume of the solution, that number being multiplied by 100 to give a percent.

“Mean Particle Size” generally refers to a particle size measured in microns by volume.

“Mean Length” or average length generally refers to the sum of the lengths divided by the number of lengths summed.

“Mean Diameter” or average diameter generally refers to the sum of the diameters divided by the number of diameters summed.

It should be noted that the singular forms “a”, “an”, “the”, and the like as used in the description and/or the claims include the plural forms unless expressly discussed otherwise. For example, if the specification and/or claims refer to “an article” or “the article” it includes one or more of such articles.

Again, it should be recognized that directional terms, such as “up”, “down”, “top” “bottom”, “fore”, “aft”, “lateral”, “longitudinal”, “radial”, “circumferential”, etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A fiber reinforced concrete composition which cures to a cured fiber reinforced concrete composite following addition of water, comprising:
a brittle inorganic matrix precursor;
a plurality of reinforcing fibers having a minimum average length of about 4 mm, present in a range from 0.5 volume percent to less than 4 volume percent based on the total volume of the cured fiber reinforced concrete composite, wherein the plurality of reinforcing fibers include polypropylene fibers; and
at least one lightweight aggregate having a mean particle size in the range of 10 μm to 1000 μm, in an amount effective to achieve a target density in the cured composite not more than 1000 kg/m³.

2. The composition of claim 1, wherein the cured fiber reinforced concrete composite has a density in the range from 700 to 1000 kg/m³ and a compressive strength in the range from 5 to 15 MPa.

3. The composition of claim 1, wherein the cured fiber reinforced concrete composite is not strain hardened.

4. The composition of claim 1, wherein the cured fiber reinforced concrete composite has a stiffness in the range from 5 to 10 GPa.

5. The composition of claim 1, wherein the reinforcing fibers have a mean diameter in the range from 10 μm to 30 μm, a mean length in the range from 4 mm to 30 mm, a strength in the range of 500 MPa to 700 MPa, and a modulus of elasticity in the range of 5 GPa to 10 GPa.

6. The composition of claim 1, wherein the lightweight aggregate includes one or more microspheres having a mean diameter in the range of 10 μm to 100 μm.

7. The composition of claim 1, wherein one or more microspheres is made of glass.

8. The composition of claim 1, wherein one or more microspheres is made of ceramic.

9. The composition of claim 1, wherein one or more microspheres is made of expanded glass.

10. The composition of claim 1, wherein the lightweight aggregate includes hollow fly ash spheres.

11. The composition of claim 10, wherein the lightweight aggregate includes one or more microspheres having a mean diameter in the range of 10 μm to 100 μm.

12. The composition of claim 1, wherein the brittle inorganic matrix precursor includes a hydraulically settable cement.

13. The composition of claim 1, wherein the lightweight aggregate further includes gas filled voids.

14. The composition of claim 1, further comprising:
a superplasticizer or a viscosity agent.

15. The composition of claim 1, further comprising:
an admixture made of acrylic.

16. A fiber reinforced concrete composition which cures to a cured fiber reinforced concrete composite following addition of water, the composition comprising:
a brittle inorganic matrix precursor;
a plurality of reinforcing fibers having a minimum average length of about 4 mm, present in a range from 0.5 volume percent to less than 4 volume percent based on the total volume of the cured fiber reinforced concrete composite;
at least one lightweight aggregate having a mean particle size in the range of 10 μm to 1000 μm, in an amount effective to achieve a target density in the cured composite not more than 1000 kg/m³, wherein the lightweight aggregate includes one or more microspheres made of glass and one or more hollow fly ash spheres.

17. The composition of claim 16, wherein the cured fiber reinforced concrete composite has a density in the range from 700 to 1000 kg/m³ and a compressive strength in the range from 5 to 15 MPa.

18. The composition of claim 16, wherein the cured fiber reinforced concrete composite has a density in the range from 700 to 1000 kg/m³ and a stiffness in the range from 5 to 10 GPa.

19. The composition of claim 16, wherein the reinforcing fibers comprise polypropylene fibers having a mean diameter in the range from 10 μm to 30 μm, a mean length in the range from 4 mm to 30 mm, a strength in the range of 500 MPa to 700 MPa, and a modulus of elasticity in the range of 5 GPa to 10 GPa.

20. The composition of claim 16, wherein one or more microspheres is made of expanded glass.

21. The composition of claim 16, wherein one or more microspheres is made of ceramic.

22. The composition of claim 16, wherein the brittle inorganic matrix precursor includes a hydraulically settable cement.

23. The composition of claim 16, wherein the lightweight aggregate further includes gas filled voids.

24. The composition of claim 16, further comprising:
a superplasticizer or a viscosity agent.

25. The composition of claim 16, wherein the lightweight aggregate includes one or more of calcium silicate hydrate, expanded clay, natural lightweight aggregate, expanded shale, vermiculite, expanded clay, expanded slate, air entrainer, foam bead, or hollow aluminum silicate sphere.

26. The composition of claim 16, further comprising:
an admixture made of acrylic.

27. The composition of claim 16, wherein the reinforcing fibers include one or more of polyvinyl alcohol, synthetic fiber, natural fiber, metallic fiber, carbon fiber, nylon, glass, AR glass, basalt, wollastonite, and acrylic fiber.

28. A method of manufacturing a cured fiber reinforced concrete composite, comprising:
mixing a brittle inorganic matrix precursor and at least one lightweight aggregate having a mean particle size in the range of 10 μm to 1000 μm, in an amount effective to achieve a target density in the cured fiber reinforced concrete composite not more than 1000 kg/m³ to form a dry mix;
adding water to the dry mix to form a wet mix;
adding a plurality of reinforcing fibers to the wet mix to form a fiber reinforced concrete composition, the reinforcing fibers having a minimum average length of about 4 mm, present in a range from 0.5 volume percent to less than 4 volume percent based on the total volume of the fiber reinforced concrete composite;
mixing the fiber reinforced concrete composite for about 5 to 7 minutes; and
curing the fiber reinforced concrete composite at a temperature of about 50 degrees Celsius.

29. The method of claim 28, wherein the curing the fiber reinforced concrete composite occurs in a humid environment.

30. The method of claim 28, further comprising:
adding a superplastizer or a viscosity agent to the wet mix.

31. The method of claim 28, wherein the lightweight aggregate includes hollow fly ash spheres.

32. The method of claim 31, wherein the lightweight aggregate includes microspheres made of glass.

33. The method of claim 28, wherein the lightweight aggregate includes microspheres made of expanded glass.

34. The method of claim 28, wherein the plurality of reinforcing fibers include polypropylene fibers having a mean diameter in the range from 10 μm to 30 μm, a mean length in the range from 4 mm to 30 mm, a strength in the range of 500 MPa to 700 MPa, and a modulus of elasticity in the range of 5 GPa to 10 GPa.
